(19) United States
(12) Patent Application Publication
(10) Pub. No.: US 2013/0312430 A1
(43) Pub. Date: Nov. 28, 2013

(54) GAS TANK REFUELING SYSTEM

(71) Applicant: The Curators of the University of Missouri, (US)

(72) Inventor: Galen J. Suppes, Columbia, MO (US)

(73) Assignee: THE CURATORS OF THE UNIVERSITY OF MISSOURI, Columbia, MO (US)

(21) Appl. No.: 13/674,633

(22) Filed: Nov. 12, 2012

Related U.S. Application Data
(60) Provisional application No. 61/629,200, filed on Nov. 12, 2011.

(51) Int. Cl. F17C 9/02

(52) U.S. Cl. CPC F17C 9/02
USPC 62/48.1

(57) ABSTRACT

A method of expansive-cooling an amount of a natural gas during transfer from a first storage container to a second storage container is provided. In addition, a system including two storage containers connected by an expander for the expansion of natural gas during the transfer from the first storage container to the second storage container is provided.

### CROSS-REFERENCE TO RELATED APPLICATION

This application claims the benefit of U.S. Provisional Patent Application Ser. No. 61/629,200, filed Nov. 12, 2011 and entitled “Gas Tank Refueling System”, the entire disclosures of which is hereby incorporated herein by reference.

### FIELD OF INVENTION

This invention relates generally to a device/system for filling gas tank storage tanks. More specifically, it has an application for refueling natural gas vehicles (tanks therein) by providing a chilled source of natural gas.

### BACKGROUND

The capacity of natural gas tanks is often diminished due to temperatures of the gas in the tank being higher than preferred. Higher temperatures lead to higher pressures which lead to maximum storage pressures being reached in natural gas tanks with less fuel in the tank than if the temperatures were lower. This is especially problematic for adsorbed natural gas tanks due to the heat of adsorption causing further increases in temperature than would otherwise be realized from typical compression and frictional losses.

### BRIEF DESCRIPTION OF THE DRAWINGS

FIG. 1 is a block flow diagram illustrating the process.

### SUMMARY AND DETAILED DESCRIPTION OF THE INVENTION

This invention is a device/system that uses expansive-cooling as a means to cool a gas as it flows from a stationary storage tank (or pipeline) into a mobile storage tank. For purposes of description, the terms “stationary” and “mobile” will be used, but these do not limit the utility of the invention and/or the actual invention.

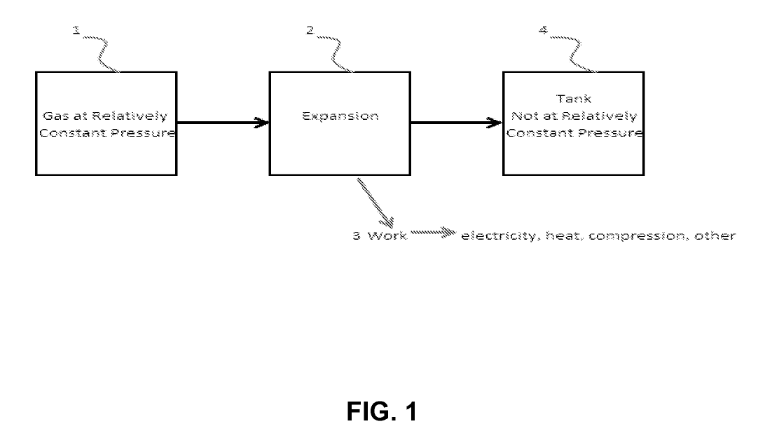

FIG. 1 summarizes the invention. A gas source 1 at relatively constant pressure is typically available from a pipeline, an underground reservoir, or large stationary storage tank. The gas in this source 1 is typically stored at ambient temperature.

An expansion process 2 with recovery of work 3 is performed as the gas flows from the stationary tank 1 to the mobile tank 4. A thermodynamic first law balance around the expansion block 2 validates that energy is removed from the gas which leads to a less-than-ambient temperature for the gas exiting the expansion 2 and entering the mobile tank. An example of an expansion device 2 is a gas turbine.

The work that is removed may be used in a variety of ways. Examples of the use are to produce electricity, to produce heat that is not put back into the gas, and compression of gases. The work can be used to compress gas going to the stationary tank to advantage provided that the heat generated during compression is removed (e.g. with a heat exchanger) before placing the compressed gas into the stationary tank.

As an ideal gas methane approximation, the exiting temperature for an ideal expansion is given by the following equation:/

Tₑₓᵢₜ/Tₑₙₜₑᵣ=(Pₑₓᵢₜ/Pₑₙₜₑᵣ)̂0.2307

As an example, if the stationary tank is at 500 psia, the tank that is being filled is at 50 psia, and the gas enters at 300 K (27 C); the expansion process chills the gas to a temperature of about 176 K (−93.6 C). With a reasonable efficiency, the chilled gas is at about 223 K (about −50 C). The chilled gas leads to increased storage capacity in the mobile tank.

In an example application where the mobile tank has pressures ranging from 5 psia (empty) to 500 psia (full); an expander capable of operating at a range of expansion ratios will deliver gases from about −100 C to ambient temperature. Ultimately, the temperatures would average at about −40 C.

Applications include, but are not limited to, the refueling of compressed gas tanks and adsorbed gas tanks. The applications include but are not limited to bulk transit of natural gas and use on natural gas vehicles.

What is claimed is:

1. A method of expansive-cooling of an amount of a natural gas during transfer from a first storage container to a second storage container, the method comprising:
transferring the amount of the natural gas from the first storage container to an expander, wherein the natural gas has a first temperature and a first pressure in the first storage container;
expanding the transferred amount of the natural gas within the expander to a second pressure and to a second temperature; and
transferring the amount of the natural gas from the expander to the second storage container;
wherein the amount of the natural gas within the second storage container has the second temperature and second pressure, the second pressure is lower than the first pressure, and the second temperature is lower than the first temperature.

2. The method of claim 1, wherein the first pressure is a stable pressure.

3. The method of claim 2, wherein the first pressure is about 500 psia.

4. The method of claim 1, wherein the first temperature is ambient temperature.

5. The method of claim 1, wherein the second pressure is not a constant pressure.

6. The method of claim 5, wherein the second pressure ranges from about 5 psia and about 500 psia.

7. The method of claim 1, wherein the second temperature ranges from about −100° C. to about ambient temperature.

8. The method of claim 1, wherein the energy removed from the amount of the natural gas in the expander is put to at least one use selected from: producing electricity, producing heat, and compressing gases.

9. The method of claim 1, wherein the amount of the natural gas stored in the second storage tank after expansive-cooling is greater than a non-cooled amount of the natural gas transferred to the second tank without expansive-cooling.

10. A system for the expansive-cooling of an amount of a natural gas during transfer from a first storage container to a second storage container, the system comprising an expander connected to the first storage container and to the second storage container, wherein:
the expander receives the amount of the natural gas from the first storage container at a first temperature and at a first pressure and delivers the amount of the natural gas at a second temperature and at a second pressure;
the second temperature is lower than the first temperature; and
the second pressure is lower than the first pressure.

11. The system of claim 10, wherein the first storage container is a stationary tank chosen from: a pipeline, an underground reservoir, a stationary storage tank, and combinations thereof.

12. The system of claim 10, wherein the second storage container is a mobile tank chosen from: a stationary storage tank, a mobile storage tank, a natural gas vehicle, a compressed gas tank, an adsorbed gas tank, and combinations thereof.

13. The system of claim 10, wherein the expander is a gas turbine.

14. The system of claim 10, wherein the first pressure is a relatively stable pressure.

15. The system of claim 14, wherein the first pressure is about 500 psia.

16. The system of claim 10, wherein the first temperature is ambient temperature.

17. The system of claim 10, wherein the second pressure is not a constant pressure.

18. The method of claim 17, wherein the second pressure ranges from about 5 psia to about 500 psia.

19. The system of claim 10, wherein the second temperature ranges from about −100° C. to about ambient temperature.

20. The method of claim 19, wherein the average second temperature is about −40° C.
